(19) United States
(12) Patent Application Publication
(10) Pub. No.: US 2024/0110367 A1
(43) Pub. Date: Apr. 4, 2024

(54) Monitoring and optimisation of water consumption

(71) Applicant: SAGEMCOM ENERGY & TELECOM SAS, RUEIL MALMAISON (FR)

(72) Inventor: Henri TEBOULLE, RUEIL MALMAISON (FR)

(21) Appl. No.: 18/476,855

(22) Filed: Sep. 28, 2023

(30) Foreign Application Priority Data
Sep. 29, 2022 (FR) FR2209901

(51) Int. Cl. E03B 7/07; G01F 1/667; G01F 15/06

(52) U.S. Cl. CPC E03B 7/075; E03B 7/072; G01F 1/667; G01F 15/068; G01F 15/005

(57) ABSTRACT

A water meter includes a valve, or first means for communicating with a valve, and a processing unit arranged for: analysing the measurements of the water consumption to produce predefined parameter measurements relating to water consumption, and detecting, from said predefined parameter measurements, operating phases of at least one predetermined system of the installation; for each predetermined system, during each phase of operation of said predetermined system. The water consumption exceeds a predetermined threshold associated with said predetermined system, at least partially close the valve for a predetermined time to limit a current water flow rate of water supplied to the installation.

The invention relates to the field of so-called “smart” water meters.

### BACKGROUND OF THE INVENTION

A water meter very conventionally comprises an internal conduit wherein the water supplied to an installation circulates through a distribution network, and a measuring device which measures the water consumption of said installation.

The measuring device is, for example, an ultrasonic measuring device comprising an upstream transducer (network side) and a downstream transducer (installation side). Each transducer acts in succession as an emitter and as a receiver of ultrasonic signals. The upstream transducer thus emits an ultrasonic signal in the internal conduit, which is received by the downstream transducer after having travelled a predefined path (of fully controlled length) in the water. Next, the downstream transducer in turn emits an ultrasonic signal which is received by the upstream transducer after having travelled the predefined path (in the other direction) in the water. The ultrasonic measuring device then evaluates the flow rate of the water on the basis of the times of flight of the ultrasonic signals between the transducers. The estimation of the water flow rate makes it possible to evaluate and to bill for the water volume consumed.

Certain so-called “smart” modern water meters, must be capable of limiting, regulating, or even cutting off the water flow rate.

In some countries, when the end-user (i.e., the subscriber) does not pay their water bills, the distributor may limit the flow rate of water supplied but must provide the “bad payer” user with a minimum flow rate. In other countries, the minimum flow rate is ensured for a certain number of days only, and then access to the water is cut off.

The regulation of the flow rate is conventionally done by controlling a motorised valve which is integrated in a cutoff box located close to the meter, even which is integrated in the meter.

Consideration is being given to using these smart water meters to help users control and optimize their water consumption. Such a functionality has an undeniable interest regarding ecology, but is also very advantageous for the buying power of the user.

### AIM OF THE INVENTION

The invention aims to control and to optimise the water consumption of an installation, in order, in particular, to reduce the water bill.

### SUMMARY OF THE INVENTION

In view of achieving this aim, a water meter is proposed, comprising:
a measuring device arranged to produce measurements of a water consumption of an installation;
a valve, or communication means with a cutoff box located outside of the meter and integrating a valve;
a processing unit arranged:
   analysing the measurements of the water consumption to produce predefined parameter measurements relating to water consumption, and detecting, from said predefined parameter measurements, operating phases of at least one predetermined system of the installation;
   for each predetermined system, during each phase of operation of said predetermined system, if the water consumption exceeds a predetermined threshold associated with said predetermined system, at least partially close the valve for a predetermined time to limit a current water flow rate supplied to the installation.

The water meter therefore detects in the measurements of the water consumption signatures each representative of the operation of a predetermined system (for example a shower, a bath), then limits the current water flow rate when the water consumption by the same system exceeds a predetermined threshold. The water flow rate is therefore only cut off in specific cases of use, with the aim of not penalising the user, but rather to warn them of overconsumption and help them optimize their water consumption.

In addition, a water meter is proposed, such as described above, wherein the predefined parameters comprise a water draw time and/or an average water flow and/or a volume of water consumed.

There is also provided a water meter as described above, wherein the at least partial closing of the valve consists in closing the valve by a predetermined closing level which is a function of a parameterizable threshold, the water meter comprising second communication means for parameterizing the parameterizable threshold.

In addition, a water meter is proposed, such as described above, wherein the at least one predetermined system comprises a shower and a bath.

In addition, a water meter is proposed, such as described above, wherein the valve is a ball valve.

There is also provided a monitoring method performed in a processing unit of an electricity meter as described above and comprising the steps of:
analysing the measurements of the water consumption to produce predefined parameter measurements relating to water consumption, and detecting, from said predefined parameter measurements, operating phases of at least one predetermined system of the installation;
for each predetermined system, during each phase of operation of said predetermined system, if the water consumption exceeds a predetermined threshold associated with said predetermined system, at least partially close the valve for a predetermined time to limit a current water flow rate of water supplied to the installation.

In addition, a monitoring method is proposed, such as described above, wherein the predefined parameters comprise a water draw time and/or an average water flow rate and/or a volume of water consumed.

In addition, a monitoring method such as described above is proposed, further comprising the steps of:
detecting a start of a water draw;
start a timer;
if the water draw is still in progress while a time measured by the timer is greater than a first time threshold:
evaluating a first average water flow rate and a first volume of water consumed during the first time threshold;
performing a first detection step consisting of checking whether the first average water flow rate belongs to a first predetermined flow rate interval and whether the first volume of water consumed is greater than a first predetermined volume threshold and, if these conditions are both met, detecting an operating phase and an upcoming overconsumption of a first predetermined system, then at least partially closing the valve during the predetermined period.

In addition, a monitoring method is proposed, such as described above, the first predetermined system being a shower.

In addition, a monitoring method such as described above is proposed, wherein if all of the conditions of the first step are not met, the method comprises the steps of:
checking whether the water draw is still in progress while a time measured by the timer is greater than a second time threshold;
if this is the case:
   evaluating a second average water flow rate and/or a second volume of water consumed during the second time threshold;
   performing a second detection step consisting in checking whether the second average water flow rate belongs to a second predetermined flow rate interval and/or whether the second volume of water consumed is greater than a second predetermined volume threshold greater than the first predetermined volume threshold and, if this or these conditions are both met, detecting an operating phase and an upcoming overconsumption of a second predetermined system, then at least partially closing the valve during the predetermined period.

In addition, a monitoring method is proposed, such as described above, the second predetermined system being a bath.

There is also provided a monitoring method as described above, wherein the at least partial closing of the valve consists in closing the valve by a predetermined closing level, the monitoring method further comprising the step, following the predetermined time during which the valve is at least partially closed, of checking whether the water draw is still in progress and, if so, of increasing the predetermined closing level by a predetermined value.

There is also provided a monitoring method as described above, wherein the predetermined closing level the is reset at the end of each day.

There is also provided a monitoring method as described above, further comprising the step, following the predetermined time during which the valve is at least partially closed, of checking whether the water draw is still in progress and, if so, of keeping the valve closed for an additional time greater than the predetermined time.

In addition, a computer program is proposed, comprising instructions which lead to the processing unit of the meter such as described above, executing the steps of the monitoring method such as described above.

There is also provided a computer-readable storage medium, storing the above-described computer program.

The invention will be best understood in the light of the following description of particular non-limiting embodiments of the invention.

### BRIEF DESCRIPTION OF THE DRAWING

Reference will be made to the accompanying drawings, among which:

FIG. 1 represents a water meter according to a first embodiment;

FIG. 2 represents steps of a monitoring method;

FIG. 3 represents a water meter according to a second embodiment.

### DETAILED DESCRIPTION OF THE INVENTION

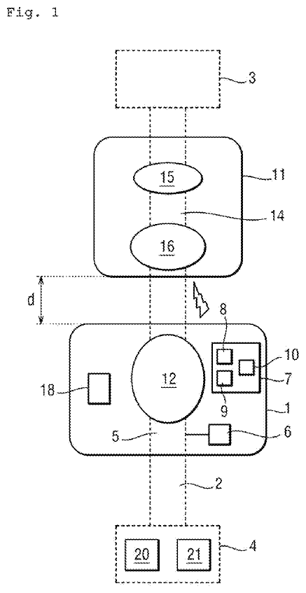

In reference to FIG. 1, the invention is, in this case, implemented in a water meter 1.

The water meter 1 is mounted on a main conduit 2 which makes it possible to connect a water distribution network 3 to an installation 4.

The meter 1 integrates a first internal conduit 5 which extends into the continuity of the main conduit 2, such that the water consumed by the installation 4 goes into the first internal conduit 5.

The meter 1 in addition integrates a measuring device 6, which is, in this case, an ultrasonic measuring device and which operates like the device described above.

The meter 1 in addition comprises a processing unit 7. The processing unit 7 comprises at least one processing component 8, which is, for example, a “general” processor, a processor specialising in the processing of the signal (or DSP, for Digital Signal Processor), a microcontroller, or a programmable logic circuit, such as an FPGA (for Field-Programmable Gate Array) or an ASIC (for Application-Specific Integrated Circuit). The processing unit 7 also comprises one or more memories 9, connected to or integrated in the processing component 8. At least one of these memories 9 forms a recording medium which can be read by a computer, on which at least one computer program is recorded, comprising instructions which lead the processing component 8 to execute at least some of the steps of the monitoring method which will be described below.

The processing unit 7 comprises a clock 10 of the RTC (for Real Time Clock) type, enabling it to integrate a calendar. A periodic resynchronisation of the clock 10 is regularly done via a communication network. The clock 10 makes it possible to implement a timer.

The meter 1 in addition comprises first communication means which enable it to communicate with a cutoff box 11 located outside of the meter 1. The distance d between the meter 1 and the cutoff box 11 is typically between 1 cm and 20 cm.

The first communication means comprise a first NFC (for Near Field Communication) interface 12. This is a “master” NFC interface.

The cutoff box 11 comprises a second internal conduit 14, a valve 15 and a second NFC interface 16 (“slave” NFC interface).

The second internal conduit 14 itself extends into the continuity of the main conduit 2 (and of the first internal conduit 5 of the meter 1).

The valve 15 is a motorized (electromechanical) multi-position valve. The valve 15 comprises a movable member which extends into the second internal conduit 14, and a current position of which can be controlled to control the water flow rate. In this case, the valve 15 is a ball valve and the movable member is therefore a ball; the current position of the ball is an angular position.

The meter 1 and the cutoff box 11 communicate via the first NFC interface 12 and the second NFC interface 16. The meter 1 can thus operate the valve 15 to control the water flow rate supplied to the installation.

Now, the monitoring method which is implemented in the processing unit 7 of the meter 1 is described.

The monitoring method aims to detect the use of a predetermined system of the installation 4 (among one or more predetermined systems), and to limit the water flow rate supplied to the installation 4 when the water consumption by this system becomes too high.

By “measurement of the water consumption”, this means any measurement representative of the water consumption: index, flow rate measurement, volume measurement, etc.

The monitoring method is, in this case, implemented at the user's initiative (but, it could be implemented systematically, or at the water distributor's or the network manager's initiative).

The detection of the operating phases of these predetermined systems consists of detecting, in the measurements of the water consumption, signatures, each representative of the use of a particular predetermined system.

Each signature corresponds to particular predefined parameter values relating to the water consumption.

The processing unit 7 thus analyse the measurements of the water consumption to produce predefined parameter measurements relating to water consumption, and detect, from said predefined parameter measurements, one or more operating phases of at least one predetermined system of the installation. By “operating phase”, this means a period during which the predetermined system operates and draws water continuously.

The predefined parameters, enabling to detect the signature of a predetermined system, comprise, for example, a water draw time and/or an average water flow rate and/or a volume of water consumed.

Then, for each predetermined system, during each phase of operation of said predetermined system, if the water consumption exceeds a predetermined threshold associated with said predetermined system, the processing unit 7 controls the valve 15 and partially closes it to limit the current water flow rate supplied to the installation 4.

The cutting off of the current water flow rate therefore consists of modifying the angular position of the ball of the valve 15 to close the valve 15 at least partially.

The at least partial closing of the valve 15 consists of closing the valve by a predetermined closing level.

The predetermined closing level may be a function of a configurable threshold X0.

In such a case, the water meter 1 includes second communication means 18 enabling to parameterize the configurable threshold.

The second communication means 18 may be of different types.

The threshold can be parameterized by the user of the installation. In such a case, the second communication means 18 can be wireless radioelectric means (NFC, Wi-Fi, Bluetooth, etc.), even wired. This can also be an interface using one or more buttons and a screen positioned on the meter 1. Naturally, in this case, the threshold can also be parameterized by an operator of the water supplier (or of the network manager) present on site.

The parameterizable threshold can also be parameterized remotely by the water distributor (or by the network manager); in this case, the second communication means 18 are for example cellular communication means.

A particular embodiment is interesting, wherein the predetermined systems of an installation comprise a shower 20 and a bath 21.

The type of water consumption (shower 20 or bath 21) is recognised by a signature which is itself defined by the following predefined parameters: water draw time, average water flow rate and the volume of water consumed.

The average water flow rate thus typically belongs to a different flow rate range (in L/minute) when the water is drawn, according to which the system which draws the water is a shower 20 or a bath 21. Likewise, the water draw time is typically less than a different time threshold, and the volume of water consumed is typically less than a different volume threshold, according to which the system which draws the water is a shower 20 or a bath 21.

Thus, in the case of a shower, we typically have:
Flow rate Range: 10 L/minute to 16 L/minute,
Time Threshold: 5 min
Volume consumption threshold: 80 L.

In the case of a bath, we typically have:
Flow rate Range: 18 L/minute to 24 L/minute,
Time Threshold: 5 min
Volume consumption threshold: 200 L.

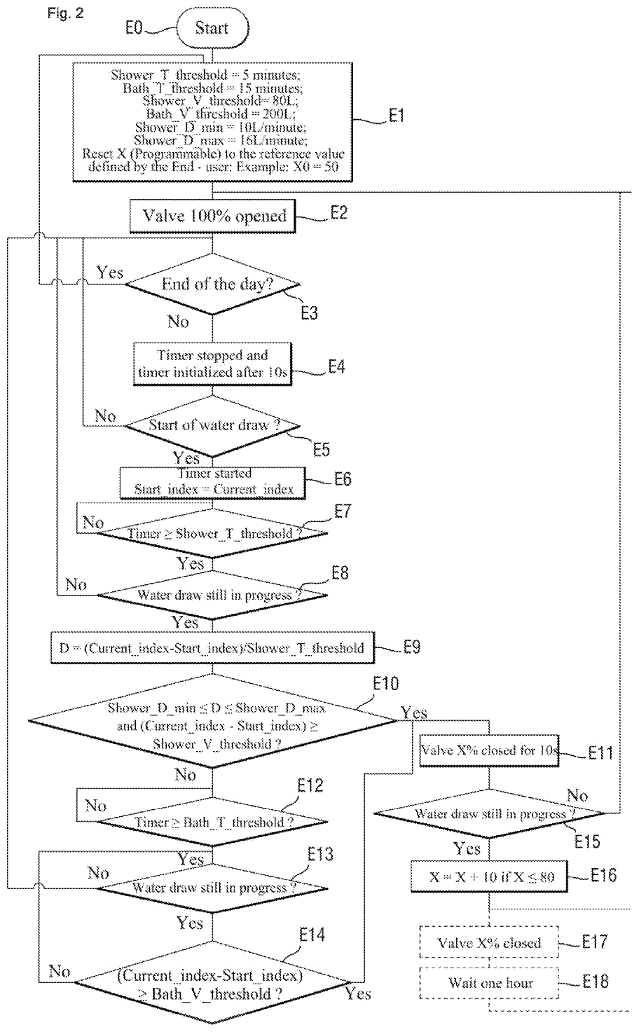

Now, in reference to FIG. 2, an example of an implementation of the monitoring method is described more specifically.

The method begins with step E0.

The following variables are initialised by the processing unit 7 (step E1):
Shower_T_threshold=5 minutes;
Bath_T_threshold=15 minutes;
Shower_V_threshold=80 L;
Bath_V_threshold=200 L;
D=10 L/minute;
D=16 L/minute;

The predetermined closing level X is initialized to a reference value (in %).

In this example, the reference value is equal to the parameterizable threshold X0, which in this example is programmed (for example) by the user.

For example, we have: X0=50 (% closure).

Thereafter, the processing unit 7 opens the valve 15 entirely, at 100% (step E2).

The processing unit 7 thus verifies if the present time corresponds to the end of the day (step E3). If this is the case, the method goes back to step E1.

Otherwise, the method moves on to step E4. The timer is stopped and then initialized. The processing unit 7 waits a waiting time, for example from 10 s, then attempts to detect the start of a water draw (i.e., that a system of the installation starts to consume water): step E5.

It is considered that a water draw has started if the water consumption is greater than or equal to a predefined threshold (for example, 1 L) for a predefined time (for example, 10 s).

As long as the water draw is not ended, the method goes back to step E3.

When the start of a water draw is detected, the processing unit 7 starts the timer (step E6).

The processing unit 7 gives the variable Start_index the value of the variable Current_index. The Start_index variable is the consumption index measured at the present time by the measuring device 6—i.e. the cumulated water volume measured at the present time.

The processing unit 7 verifies that the time measured by the timer is greater than (here greater than or equal to) a first time threshold, which is equal to Shower_T_threshold (step E7). As long as it is not the case, the method loops back to step E7.

When this is the case, the processing unit 7 checks whether the water draw is still in progress (step E8). If this is not the case, the method goes back to step E3.

If this is the case, and therefore if the water draw is still in progress while the time measured by the timer is greater than or equal to the first time threshold, the processing unit 7 evaluates a first volume of water consumed and a first average water flow rate during the first time threshold (step E9).

Here, the processing unit 7 evaluates the average water flow rate by using the formula:

Current_index−Start_index,

and the first mean water flow rate D by using the formula:

D=(Current_index−Start_index)/Shower_T_threshold.

The processing unit 7 then performs a first detection step consisting in checking whether the first average water flow rate belongs to a first predetermined flow rate interval and whether the first volume of water consumed is greater (here greater than or equal to) a first predetermined volume threshold:

Shower_D_min≤D≤Shower_D_max and

(Current index−Start index)≥Shower_V_threshold (step E10).

If these conditions are both met, the processing unit 7 detects an upcoming operating phase and overconsumption of a first predetermined system, which is the shower 20. The method goes to step E11.

In step E10, if the conditions are not both met, the processing unit 7 verifies that the time measured by the timer is greater than (here greater than or equal to) a second time threshold, which is equal to Bath_T_threshold (step E12). As long as it is not the case, the method loops back to step E12.

When this is the case, the processing unit 7 checks whether the water draw is still in progress (step E13). If this is not the case, the method goes back to step E3.

If the water draw is still in progress, the treatment unit 7 performs a second detection step consisting in checking whether the second average water flow rate belongs to a second predetermined flow interval and/or whether the second volume of water consumed is greater than (in this case greater than or equal to) a second predetermined volume threshold greater than the first predetermined volume threshold (step E14).

Here, the processing unit 7 checks only the condition relating to the second volume of water consumed:

(Current_Index−Start_Index)≥Bath_V_Threshold (step E14).

If this condition is met, the processing unit 7 detects an upcoming operating phase and overconsumption of a second predetermined system, which is the bath 21. The method then goes to step E11.

At step E14, if the condition is not met, the method goes back to step E13.

In step E11, the current water flow rate is therefore limited: the valve 15 is partially closed, for a predetermined time, by a predetermined closing level, which is first of all equal to X0% (i.e. the parameterizable threshold in %).

The predetermined time is, for example, equal to 10 s.

This limitation of the current water flow rate makes it possible to warn the user of its overconsumption.

Thereafter, following the at least partial closure of the valve 15, the processing unit 7 checks whether the water draw is still in progress (step E15). If this is the case, the processing unit 7 increases the predetermined closing level by a predetermined value, here equal to 10% (step E16):

X=X+10 if X≤80%.

It can thus be seen that the processing unit 7 is capable of increasing the predetermined closing level up to a maximum cap, equal to 80%, for example.

The method then goes back to step E2. This means that, until the end of the day, and the reset of the predetermined closing level, when a new overconsumption is detected, the closing level of valve 15 will be greater (by 10%) to warn the user more effectively.

Optionally, provision may be made, following step E16, to keep the valve partially closed at X% (step E17), and to wait in this situation for an additional time (step E18). This additional time is greater than the predetermined time, and is for example equal to 1 hour. Following the additional time, the method then goes back to step E2 and again, X keeps its current value until the end of the day.

It should be noted that the value of the parameterizable threshold X0, which is the “initial” closing level of the valve 15, is decided here by the user, who can modify this value as he wishes. The user can give to X0 a permissive value, i.e. relatively low (here X0=50%), to avoid, in the event of a reduction in the water flow rate, generating alarms in the washing machine or dishwasher, typically, in the event of insufficient water flow rate. Alternatively, X0 can be set by the water distributor or the network manager (for example on the basis of periodically recovered load curves).

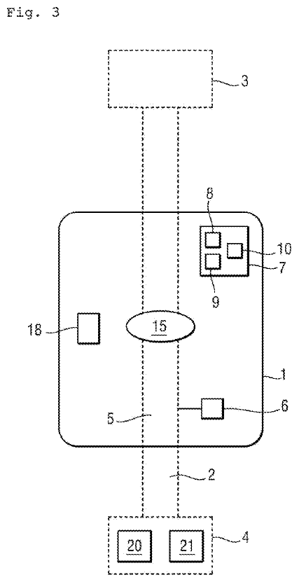

In a second embodiment, in reference to FIG. 3, the valve 15 is not this time located in a cutoff box outside of the meter 1, but is integrated in the meter 1. The monitoring method is implemented in the same way if this is not that, in this configuration, the meter 1 does not need to communicate with a piece of external equipment: the processing unit 7 directly operates the valve 15.

Naturally, the invention is not limited to the implementations described, but covers any variant coming within the ambit of the invention as defined by the claims.

Many variants of the method of FIG. 2 are of course conceivable. For example, in step E14, the conditions checked could relate to the average flow rate and the volume consumed—and not only to the volume consumed.

The signatures of the predetermined systems are not necessarily defined by the water draw time, the average water flow rate and the volume of water consumed, but can be defined by only one or two of these predefined parameters.

The predefined parameters can moreover be different from those described in this case, and could, for example, comprise a consumption gradient or a current flow (and not average).

The predetermined systems of the installation, whose consumption is monitored, are not necessarily a shower and a bath. It could be other systems: garden watering system, pool filling, etc.

1. A water meter comprising:
a measuring device arranged to produce measurements of a water consumption of an installation;
a valve, or first means for communicating with a cutoff box located outside of the meter and integrating a valve;
a processing unit arranged:
analysing the measurements of the water consumption to produce predefined parameter measurements relating to water consumption, and detecting, from said predefined parameter measurements, operating phases of at least one predetermined system of the installation;
for each predetermined system, during each phase of operation of said predetermined system, if the water consumption exceeds a predetermined threshold associated with said predetermined system, at least partially close the valve for a predetermined time to limit a current water flow rate supplied to the installation,
wherein the at least partial closing of the valve consists in closing the valve by a predetermined closing level which is a function of a parameterizable threshold (X0), the water meter comprising second communication means for parameterizing the parameterizable threshold.

2. The water meter according to claim 1, wherein the predefined parameters comprise a water draw time and/or an average water flow rate and/or a volume of water consumed.

3. The water meter according to claim 1, wherein the at least one predetermined system comprises a shower and a bath 21).

4. The water meter according to claim 1, wherein the valve is a ball valve.

5. A monitoring method implemented in the processing unit of a water meter according to claim 1, and comprising the steps of:
analysing the measurements of the water consumption to produce predefined parameter measurements relating to water consumption, and detecting, from said predefined parameter measurements, operating phases of at least one predetermined system of the installation;
for each predetermined system, during each phase of operation of said predetermined system, if the water consumption exceeds a predetermined threshold associated with said predetermined system, at least partially close the valve for a predetermined time to limit a current water flow rate supplied to the installation.

6. The monitoring method according to claim 5, wherein the predefined parameters comprise a water draw time and/or an average water flow rate and/or a volume of water consumed.

7. The monitoring method according to claim 6, comprising the steps of:
detecting a start of a water draw;
start a timer;
if the water draw is still in progress while a time measured by the timer is greater than a first time threshold:
evaluating a first average water flow rate and a first volume of water consumed during the first time threshold;
performing a first detection step consisting of checking whether the first average water flow rate belongs to a first predetermined flow rate interval and whether the first volume of water consumed is greater than a first predetermined volume threshold and, if these conditions are both met, detecting an operating phase and an upcoming overconsumption of a first predetermined system, then at least partially closing the valve during the predetermined period.

8. The monitoring method according to claim 7, wherein the first predetermined system is a shower.

9. The monitoring method according to claim 7, wherein, if the conditions of the first detection step are not all met, the method comprises the steps of:
checking whether the water draw is still in progress while a time measured by the timer is greater than a second time threshold;
if this is the case:
evaluating a second average water flow rate and/or a second volume of water consumed during the second time threshold;
performing a second detection step consisting of checking whether the second average water flow belongs to a second predetermined flow interval and/or whether the second volume of water consumed is greater than a second predetermined volume threshold greater than the first predetermined volume threshold and, if these conditions are all met, detecting an operating phase and an upcoming overconsumption of a second predetermined system, then at least partially closing the valve during the predetermined period.

10. The monitoring method according to claim 9, the second predetermined system being a bath (21).

11. The monitoring method according to claim 7, wherein the at least partial closure of the valve consists in closing the valve by a predetermined closure level, the monitoring method further comprising the step, following the predetermined time during which the valve is at least partially closed, of checking whether the water draw is still in progress and, if so, of increasing the predetermined closure level by a predetermined value.

12. The monitoring method according to claim 11, wherein the predetermined closing level is reset at the end of each day.

13. The monitoring method according to claim 7, further comprising the step, following the predetermined time during which the valve is at least partially closed, of checking whether the water draw is still in progress and, if so, of keeping the valve closed for an additional time greater than the predetermined time.

14. (canceled)

15. A non-transitory storage media which can be read by a computer, on which a computer program is stored, wherein the computer program comprising instructions which leads to the processing unit of the water meter according to claim 1, executing a monitoring method implemented in the processing unit of the water meter, the method comprising the steps of:
analysing the measurements of the water consumption to produce predefined parameter measurements relating to water consumption, and detecting, from said predefined parameter measurements, operating phases of at least one predetermined system of the installation;
for each predetermined system, during each phase of operation of said predetermined system, if the water consumption exceeds a predetermined threshold associated with said predetermined system, at least partially close the valve for a predetermined time to limit a current water flow rate supplied to the installation.
